(19) United States
(12) Patent Application Publication
(10) Pub. No.: US 2026/0199867 A1
(43) Pub. Date: Jul. 16, 2026

(54) LOW SODIUM ACTIVATED ALUMINA MATERIALS

(71) Applicant: BASF Corporation, Florham Park, NJ (US)

(72) Inventors: Dana Rehms MOONEY, Natchez, LA (US); William B. DOLAN, Yardley, PA (US)

(73) Assignee: BASF Corporation, Florham Park, NJ (US)

(21) Appl. No.: 19/135,499

(22) PCT Filed: Dec. 14, 2023
(86) PCT No.: PCT/US2023/084053

§ 371 Date: Jun. 4, 2025

Related U.S. Application Data
(60) Provisional application No. 63/432,735, filed on Dec. 15, 2022.
(60) Provisional application No. 63/432,737, filed on Dec. 15, 2022.
(60) Provisional application No. 63/432,739, filed on Dec. 15, 2022.

(51) Int. Cl. B01J 20/08; B01J 20/28; B01J 20/30; B01J 21/04; B01J 37/06; B01J 37/08; C01F 7/441

(52) U.S. Cl. CPC B01J 20/08; B01J 20/28061; B01J 20/3028; B01J 20/3071; B01J 20/3078; B01J 21/04; B01J 37/06; B01J 37/08; C01F 7/441; C01P 2002/72; C01P 2006/12

(57) ABSTRACT

Disclosed in certain embodiments are activated alumina materials having an Na₂O content of no more than about 4000 ppm.

### CROSS-REFERENCE TO RELATED APPLICATION(S)

This application claims the benefit of priority of U.S. Provisional Patent Application No. 63/432,735, filed Dec. 15, 2022. U.S. Provisional Patent Application No. 63/432,737, filed Dec. 15, 2022, and U.S. Provisional Patent Application No. 63/432,739, filed Dec. 15, 2022, the disclosures of which are hereby incorporated by reference herein in their entireties.

### BACKGROUND

Dehydration of natural gas to cryogenic specifications is critical in the pretreatment process for liquified natural gas (LNG) production. Zeolitic molecular sieves are used in such processes because they allow for the natural gas to meet the required dewpoint for liquefaction. Failure to reach this required dewpoint may result in the inability to maintain the necessary gas flow to the liquefaction section, which can constrain or shutdown the production of LNG.

Hydrothermal damage and retrograde condensation in dehydrator vessels during regeneration and adsorption lead to degradation of the molecular sieve adsorbent through leaching of the clay binder and loss of adsorption capacity. In addition, the presence of sulfur-containing hydrocarbons (e.g., mercaptans) may lead to the formation of H₂S under the process conditions, which may also have a deleterious effect on the molecular sieve. Such effects can result in an increase in pressure drop and an uneven distribution of adsorption and/or regeneration flow, ultimately requiring premature replacement of the adsorbent.

There is a need to develop materials to mitigate the effects of hydrothermal damage.

### SUMMARY OF THE DISCLOSURE

The following presents a simplified summary of various aspects of the present disclosure in order to provide a basic understanding of such aspects. This summary is not an extensive overview of the disclosure. It is intended to neither identify key or critical elements of the disclosure, nor delineate any scope of the particular embodiments of the disclosure or any scope of the claims. Its sole purpose is to present some concepts of the disclosure in a simplified form as a prelude to the more detailed description that is presented later.

One aspect of the present disclosure relates to activated alumina having an Na₂O content of no more than about 4000 ppm, no more than about 3500 ppm, no more than about 3000 ppm, no more than about 2500 ppm, no more than about 2000 ppm, no more than about 1500 ppm, no more than about 1000, or no more than about 500 ppm, the activated alumina comprising a chi alumina phase.

In at least one embodiment, the activated alumina is steamed at least once, and a loss of surface area of the activated alumina after steaming is less than 20% compared to the activated alumina without steaming.

In at least one embodiment, the activated alumina further comprises boehmite and gamma alumina phases.

In at least one embodiment, a BET surface area of the activated alumina adsorbent is less than about 400 m²/g, or from about 200 m²/g to about 400 m²/g.

In at least one embodiment, the activated alumina is formed from flash calcined gibbsite.

In at least one embodiment, when measured by X-ray diffraction (XRD), the XRD spectrum of the activated alumina exhibits a peak at about 42.5° having a relative intensity of at least about 0.2 compared to a gamma alumina peak in the XRD spectrum.

Another aspect of the present disclosure relates to a catalyst comprising the activated alumina of any of the preceding embodiments as a support material.

Another aspect of the present disclosure relates to an adsorbent comprising the activated alumina of any of the preceding embodiments.

Another aspect of the present disclosure relates to activated alumina having an Na₂O content of no more than about 4000 ppm, no more than about 3500 ppm, no more than about 3000 ppm, no more than about 2500 ppm, no more than about 2000 ppm, no more than about 1500 ppm, no more than about 1000, or no more than about 500 ppm, the activated alumina having been formed from flash calcined gibbsite.

Another aspect of the present disclosure relates to a method of producing low-soda activated alumina having an Na₂O content of no more than about 4000 ppm, no more than about 3500 ppm, no more than about 3000 ppm, no more than about 2500 ppm, no more than about 2000 ppm, no more than about 1500 ppm, no more than about 1000, or no more than about 500 ppm. In at least one embodiment, the method comprises: acid washing activated alumina beads to leach Na₂O, the activated alumina beads having an initial Na₂O content greater than 4000 ppm prior to the acid washing; and subsequently drying the activated alumina beads.

In at least one embodiment, the acid washing comprises acid washing with hydrochloric acid at a temperature of greater than 90° C.

In at least one embodiment, the method further comprises: steaming the low-soda activated alumina in a sealed vessel, where a loss of surface area of the activated alumina after steaming is less than 20% compared to the activated alumina without steaming.

In at least one embodiment, the method further comprises: agglomerating milled gibbsite alumina powder to form gibbsite beads; flash calcining the gibbsite beads to form the low-soda activated alumina.

In at least one embodiment, the activated alumina further comprises boehmite and gamma alumina phases.

In at least one embodiment, a BET surface area of the low-soda activated alumina is less than about 400 m²/g, or from about 200 m²/g to about 400 m²/g.

In at least one embodiment, when measured by X-ray diffraction (XRD), the XRD spectrum of the low-soda activated alumina exhibits an peak at about 42.5°.

In at least one embodiment, the method further comprises incorporating the low-soda activated alumina into a catalyst composition as a support material.

In at least one embodiment, the method further comprises incorporating the low-soda activated alumina into an adsorbent bed.

As used herein, the term “adsorbent material” refers to a material that can adhere gas molecules, ions, or other species within its structure. Specific materials include but are not limited to clays, metal organic framework, activated alumina, silica gel, activated carbon, molecular sieve carbon, zeolites (e.g., molecular sieve zeolites), polymers, and resins. Certain adsorbent materials may preferentially or selectively adhere particular species.

As used herein, the term “adsorption capacity” refers to a working capacity for an amount of a chemical species that an adsorbent material can adsorb under specific operating conditions (e.g., temperature and pressure). The units of adsorption capacity, when given in units of g/L, correspond to grams of adsorbed gas per liter of adsorbent.

As used herein, the term “particles”, as used herein, refers to a collection of discrete portions of a material each having a largest dimension ranging from 0.1 μm to 50 mm. The morphology of particles may be crystalline, semi-crystalline, or amorphous. The term “particle” may also encompass powders down to 1 nm in radius. The size ranges disclosed herein can be mean/average or median size, unless otherwise stated. It is noted also that particles need not be spherical, but may be in a form of cubes, cylinders, discs, or any other suitable shape as would be appreciated by one of ordinary skill in the art. A “bead” or “granule” may be a type of particle.

As used herein, “flash calcined gibbsite,” refers to gibbsite that has been passed through a hot column, e.g., at a temperature of about 500° C. to about 800° C. to form a mixture of steam and a substantially anhydrous alumina, where said substantially anhydrous alumina is referred to as flash calcined gibbsite. The term “calcined flash calcined gibbsite,” refers to flash calcined gibbsite that has been subjected to further calcination, e.g., at about 700° C. to about 900° C., or about 750° C. to about 850° C., or about 800° C.

As used herein, “surface area” refers to surface area measurements as determined by the Brunauer-Emmett-Teller (BET) method according to DIN ISO 9277:2003-05 (which is a revised version of DIN 66131), and may also be referred to as “BET surface area”. The specific surface area is determined by a multipoint BET measurement in the relative pressure range from 0.05-0.3 p/p₀.

As used herein, the term “about,” as used in connection with a measured quantity, refers to the normal variations in that measured quantity, as expected by the skilled artisan making the measurement and exercising a level of care commensurate with the objective of measurement and the precision of the measuring equipment. For instance, “about” may mean the numeric value may be modified by ±5%, 4%, ±3%, 2%, ±1%, ±0.5%, 0.4%, ±0.3%, ±0.2%, ±0.1% or ±0.05%. All numeric values are modified by the term “about” whether or not explicitly indicated. Numeric values modified by the term “about” include the specific identified value. For example “about 5.0” includes 5.0.

### BRIEF DESCRIPTION OF THE DRAWINGS

The present disclosure is illustrated by way of example, and not by way of limitation, in the figures of the accompanying drawings, in which:

FIG. 1 is a plot showing surface area loss as a function of initial Na₂O content for various samples including samples produced in accordance with embodiments of the disclosure;

FIG. 2 shows XRD spectra revealing a chi alumina peak for alumina materials prepared in accordance with embodiments of the disclosure; and

FIG. 3 shows XRD spectra of low sodium alumina materials compared to low sodium alumina materials prepared in accordance with embodiments of the disclosure.

### DETAILED DESCRIPTION

The embodiments described herein relate to activated alumina materials for use as adsorbent materials (e.g., for removal of water from gas streams, such as natural gas streams) or support materials for catalytic metals. In at least one embodiment, the activated alumina is in the form of particles, such as beads, granules, or powder. Various embodiments of the activated alumina contain relatively low amounts of sodium in the form of Na₂O, for example, at no greater than 5000 ppm.

In various embodiments, the activated alumina materials may be produced as described in the Illustrative Examples section below. For example, activated alumina may be prepared from flash calcined gibbsite, followed by a leaching procedure to reduce Na₂O content. The methods described herein may result in an activated alumina having low Na₂O content an exhibiting a chi phase when characterized by an X-ray diffraction. The activated alumina may further exhibit boehmite and gamma alumina phases in addition to the chi phase. For example, the XRD spectrum of may exhibit a peak from about 420 to 440 (at about 42.5°) corresponding to the chi phase, having a relative intensity of at least about 0.1, at least about 0.2, at least about 0.3, at least about 0.4, or at least about 0.5 compared to a gamma alumina peak in the XRD spectrum (e.g., any peak corresponding to the (311), (400), or (440) reflections of gamma alumina).

In at least one embodiment, the resulting activated alumina has an Na₂O content of no more than about 5000 ppm, no more than about 4500 ppm, no more than about 4000 ppm, no more than about 3500 ppm, no more than about 3000 ppm, no more than about 2500 ppm, no more than about 2000 ppm, no more than about 1500 ppm, no more than about 1000 ppm, or no more than about 500 ppm (e.g., from about 250 ppm to about 750 ppm). In at least one embodiment, the Na₂O content is no less than about 10 ppm, no less than about 25 ppm, no less than about 50 ppm, no less than about 75 ppm, no less than about 100 ppm, no less than about 150 ppm, no less than about 200 ppm, or no less than about 250 ppm.

In at least one embodiment, the activated alumina is steamed at least once (e.g., two to three separate steaming procedures). In at least one embodiment, a loss of surface area of the activated alumina after steaming is less than about 50%, less than about 40%, less than about 30%, less than about 20%, less than about 15%, or less than about 10% compared to the activated alumina without steaming or prior to steaming.

In at least one embodiment, a BET surface area of the activated alumina is no greater than about 500 m²/g, no greater than about 450 m²/g, no greater than about 400 m²/g, no greater than about 350 m²/g, no greater than about 300 m²/g, no greater than about 250 m²/g, no greater than about 200 m²/g, no greater than about 150 m²/g, or within any range defined therebetween (e.g., from about 200 m²/g to about 400 m²/g).

In an exemplary method, an activated alumina material having an Na₂O content of less than about 4000 ppm is produced as follows: (1) activated alumina beads (having an initial Na₂O content of greater than 4000 ppm) are acid washed (e.g., with HCl) for a sufficient duration and at an elevated temperature (e.g., at least about 90° C.) to reduce Na₂O content to no more than about 4000 ppm (e.g., from about 250 ppm to about 750 ppm); (2) the acid washed activated alumina beads are dried; and (3) the dried activated alumina beads are steamed in a sealed vessel in at least one steaming procedure.

In at least one embodiment, the activated alumina beads are formed by first agglomerating milled gibbsite alumina powder to form gibbsite beads, and subsequently flash calcining the gibbsite beads to form the activated alumina beads. In at least one embodiment, the gibbsite alumina powder may have an Na₂O content that is no greater than 4000 ppm (e.g., no greater than 2500 ppm) prior to forming the gibbsite beads. In such embodiments, an acid washing step to reduce Na₂O may be omitted.

The following exemplary embodiments are now described:

Embodiment 1: An activated alumina having an Na₂O content of no more than about 4000 ppm, the activated alumina comprising a chi alumina phase.

Embodiment 2: The activated alumina of Embodiment 1, wherein the activated alumina has an Na₂O content of no more than about 3500 ppm, no more than about 3000 ppm, no more than about 2500 ppm, no more than about 2000 ppm, no more than about 1500 ppm, no more than about 1000, or no more than about 500 ppm.

Embodiment 3: The activated alumina of Embodiment 1, wherein the activated alumina is steamed at least once, and wherein a loss of surface area of the activated alumina after steaming is less than 20% compared to the activated alumina without steaming.

Embodiment 4: The activated alumina of any one of the preceding Embodiments, further comprising boehmite and gamma alumina phases.

Embodiment 5: The activated alumina of any one of the preceding Embodiments, wherein a BET surface area of the activated alumina adsorbent is less than about 400 m²/g, or from about 200 m²/g to about 400 m²/g.

Embodiment 6: The activated alumina of any one of the preceding Embodiments, wherein the activated alumina is formed from flash calcined gibbsite.

Embodiment 7: The activated alumina of Embodiment 1, wherein, when measured by X-ray diffraction (XRD), the XRD spectrum of the activated alumina exhibits a peak at about 42.5° having a relative intensity of at least about 0.2 compared to a gamma alumina peak in the XRD spectrum.

Embodiment 8: A catalyst comprising the activated alumina of any one of the preceding Embodiments as a support material.

Embodiment 9: An adsorbent comprising the activated alumina of any one of the preceding Embodiments.

Embodiment 10: An activated alumina having an Na₂O content of no more than about 4000 ppm, no more than about 3500 ppm, no more than about 3000 ppm, no more than about 2500 ppm, no more than about 2000 ppm, no more than about 1500 ppm, no more than about 1000, or no more than about 500 ppm, the activated alumina having been formed from flash calcined gibbsite.

Embodiment 11: A method of producing low-soda activated alumina having an Na₂O content of no more than about 4000 ppm, no more than about 3500 ppm, no more than about 3000 ppm, no more than about 2500 ppm, no more than about 2000 ppm, no more than about 1500 ppm, no more than about 1000, or no more than about 500 ppm, the method comprising: acid washing activated alumina beads to leach Na₂O, wherein the activated alumina beads have an initial Na₂O content greater than 4000 ppm prior to the acid washing; and subsequently drying the activated alumina beads.

Embodiment 12: The method of Embodiment 11, wherein the acid washing comprises acid washing with hydrochloric acid at a temperature of greater than 90° C.

Embodiment 13: The method of any one of Embodiments 11-12, further comprising: steaming the low-soda activated alumina in a sealed vessel, wherein a loss of surface area of the activated alumina after steaming is less than 20% compared to the activated alumina without steaming.

Embodiment 14: The method of any one of Embodiments 11-13, further comprising: agglomerating milled gibbsite alumina powder to form gibbsite beads; flash calcining the gibbsite beads to form the low-soda activated alumina.

Embodiment 15: The method of any one of Embodiments 11-14, wherein the activated alumina of Embodiment 1, further comprising boehmite and gamma alumina phases.

Embodiment 16: The method of any one of Embodiments 11-15, wherein a BET surface area of the low-soda activated alumina is less than about 400 m²/g, or from about 200 m²/g to about 400 m²/g.

Embodiment 17: The method of any one of Embodiments 11-16, wherein, when measured by X-ray diffraction (XRD), the XRD spectrum of the low-soda activated alumina exhibits an peak at about 42.5°.

Embodiment 18: The method of any one of Embodiments 11-17, further comprising incorporating the low-soda activated alumina into a catalyst composition as a support material.

Embodiment 19: The method of any one of Embodiments 11-18, further comprising incorporating the low-soda activated alumina into an adsorbent bed.

### Illustrative Examples

The following examples are set forth to assist in understanding the disclosed embodiments and should not, of course, be construed as specifically limiting the embodiments described and claimed herein. Such variations of the embodiments, including the substitution of all equivalents now known or later developed, which would be within the purview of those skilled in the art, and changes in formulation or minor changes in experimental design, are to be considered to fall within the scope of the embodiments incorporated herein.

### Example 1

A sample of F-200 7X14 activated alumina beads with 0.5 wt % Na₂O (available from BASF) was washed with 1 molar HCl using 50 milliliters of solution added to a beaker containing 25 grams of the beads. The mixture was heated on a standard hot plate to approximately 95° C. and allowed to sit for a period of 60 minutes. The liquid was decanted, and the beads were washed with 100 grams of deionized water twice. The resulting beads were dried in a static furnace at 115° C. for 1.5 hours. The dried sample was further heat treated in a static furnace at 250° C. for 1 hour. The resulting sample was again leached with 1M HCl, washed with deionized water twice, and dried as described above. This yielded a sample containing 0.05 wt % Na₂O (labeled as Sample C0). The original sample of F-200 7X14 activated alumina beads without treatment was labeled as Sample A0.

### Example 2

A sample of F-200 7X14 activated alumina beads (available from BASF) with 0.5 wt % Na₂O was washed with 0.1 molar HCl using 50 milliliters of solution added to a beaker containing 25 grams of the beads. The mixture was heated on a standard hot plate to approximately 95° C. and allowed to sit for a period of 60 minutes. The liquid was decanted, and the beads were washed with 100 grams of deionized water twice. The resulting beads were dried in a static furnace at 115° C. for 1.5 hours. The dried sample was further heat treated in the static furnace at 250° C. for 1 hour. The resulting sample was again leached with 1M HCl, washed with deionized water twice, and dried as described above. This yielded a sample containing 0.25 wt % Na₂O (labeled as Sample B0).

### Example 3

The following procedure was performed with Samples A0, B0, and C0, using a vessel manufactured by Wisconsin Aluminum Foundry (Aluminum Pressure Cooker model #915) and having the following dimensions: 31 cm inner diameter and 31 cm overall height (about 15 liters total volume).

The samples were placed in the vessel with water in the bottom. 20 g of each sample was placed in individual cylindrical aluminum louvre pans (7.6 cm diameter and 2 cm height), which were then put on a grated platform within the vessel. About 7.5 L (7500 grams) of water was added to the vessel to achieve a liquid level of about 11 cm (about 50% full). The three aluminum louvre pans containing each of the different samples were evenly placed on top of the grated platform. The vessel was heated until the water began to boil. Then the vessel was then sealed, and temperature and steam pressure was allowed to increase to 120° C. and 15 psig, respectively. Once the temperature reached the target (after about 30-45 min), the conditions were maintained for a period of 7.5 hours, while the vessel was allowed to vent excess steam pressure. The steamed samples were split evenly to yield Samples A0(steam), A1(steam), B0(steam), B1(steam), C0(steam), and C1(steam).

### Example 4

Samples A0(steam), B0(steam), and C0(steam) were dried at 115° C. overnight and then placed in the same sealed vessel with water (as described in Example 3) for a second time. The samples were placed in the aluminum louvre pans as previously described and then placed on the grated platform within the vessel containing water. The vessel was heated as in Example 3 to 120° C. and allowed to build up stream pressure to 15 psig. Conditions were maintained for a period of 7.5 hours while the vessel was allowed to vent excess steam pressure. This process yielded Samples A2(steam), B2(steam) and C2(steam).

### Example 5

A portion of sample C2(steam) was dried at 115° C. overnight and then placed in the same sealed vessel with water (as described in Example 3) for a third time. The sample was placed in the aluminum louvre pan as previously described and then placed on the grated platform within the vessel containing water. The vessel was heated as in Example 3 to 120° C. and allowed to build up stream pressure to 15 psig. Conditions were maintained for a period of 7.5 hour while the vessel was allowed to vent excess steam pressure. This process yielded Sample C3(steam).

### Example 6

Samples A0, B0, C0, A1(steam), B1(steam), C1(steam), A2(steam), B2(steam), C2(steam), and C3(steam) were dried according to the following method: 6 grams of each sample was placed in an individual 12 mL ceramic crucible and dried overnight at 115° C. The alumina beads were then placed in individual glass tubes and heated for 2 hours at 300° C. with a nitrogen purge at >5 mL/min. The drying/purging resulted in Samples A0(dry), B0(dry), C0(dry), A1(dry), B1(dry), C1(dry), A2(dry), B2(dry), C2(dry) and C3(dry).

### Example 7

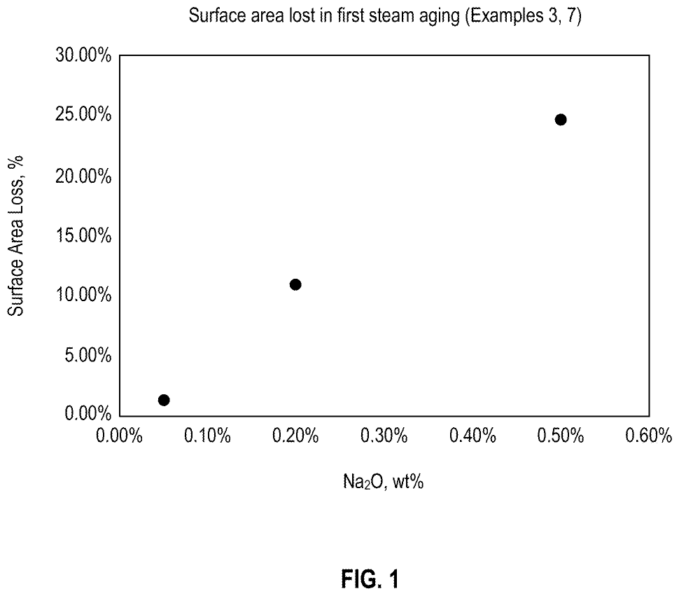

BET surface area was measured for each of Samples A0(dry), B0(dry), C0(dry), A1(dry), B1(dry), C1(dry), A2(dry), B2(dry), C2(dry), and C3(dry) using a Micromeritics TriStar II Plus instrument. The BET surface area was measured for each sample using about 0.35 g of beads. A fast evacuation option was chosen with P/Po points of 0.06, 0.08, 0.12, 0.16, and 0.20 yielding a 5-point BET surface area. The analytical test resulted in surface areas as shown in Table 1. FIG. 1 reveals that the surface area loss is correlated to the residual sodium content of the beads.

TABLE 1
Surface areas of low sodium alumina samples

| Sample ID | Na₂O (ppm) | Surface Area (m²/g) |
|---|---|---|
| A0(dry) | 5000 | 341 |
| B0(dry) | 2500 | 340 |
| C0(dry) | 500 | 354 |
| A1(dry) | 5000 | 257 |
| B1(dry) | 2500 | 303 |
| C1(dry) | 500 | 350 |
| A2(dry) | 5000 | 206 |
| B2(dry) | 2500 | 281 |
| C2(dry) | 500 | 341 |
| C3(dry) | 500 | 312 |

### Example 8

Samples A0(dry), B0(dry), C0(dry), A1(dry), B1(dry), C1(dry), and C3(dry) were evaluated for water adsorption capacity. Water capacity was measured by placing thirds of each warm adsorbent sample in plastic crucibles with tight fitting lids. The samples were allowed to cool down and then the uncovered plastic crucibles were placed in three desiccators with specific aqueous salt solutions of K₂SO₄, NaBr, and LiCl. The solutions were prepared to provide 97%, 58%, and 11% relative humidity (RH), respectively. Saturated solutions of the salts were prepared as outlined in Table 2, and as now described: 250 mL of deionized water was added into a heat resistant container, followed by the amount of the salts shown in Table 2. The solutions were placed on a hotplate and brought to 90° C. while stirring with a magnetic stir bar. The warm solutions were then transferred to the appropriate desiccator (described above), and the lid was replaced allowing the solutions to cool to ambient temperature. An excess of salt crystals is visible at room temperature.

TABLE 2
Saturated salt solution recipes

| | 97% RH | 58% RH | 11% RH |
|---|---|---|---|
| | (K₂SO₄) | (NaBr) | (LiCl) |
| per 250 ml | 60.0 g | 302.5 g | 325.0 g |

Each salt solution was added to the bottom of a 230 mm diameter Pyrex implosion proof vacuum desiccator, with a 55/38 sleeve joint. The solution volume in each of the three desiccators was approximately 2500 mL and the sample in the crucible was approximately 5 g. When the samples were placed in the desiccators, a vacuum was pulled on each to 28-30″ Hg. The vacuum was maintained >25″ Hg for 48 hours at an ambient temperature of about 25° C.

Water adsorption capacity was determined by weighing the cooled samples before and after exposing the uncovered crucibles to the three different RH conditions. It is important to cap the crucibles of the dried samples as they cool and also before the final weighing step to avoid either gain or loss of water due to changes in laboratory conditions.

The resulting water adsorption capacities at 11%, 58%, and 97% RH for the seven samples is summarized in Table 3.

TABLE 3
Water capacity of alumina samples

| | | Static Water Capacity (wt %) | | |
|---|---|---|---|---|
| Sample | Na2O | 11% | 58% | 97% |
| ID | (ppm) | RH | RH | RH |
| A0(dry) | 5000 | 7.6 | 20.3 | 41.3 |
| B0(dry) | 2500 | 7.8 | 19.7 | 40.1 |
| C0(dry) | 500 | 9.3 | 21.3 | 44.8 |
| A1(dry) | 5000 | 5.8 | 15.0 | 38.2 |
| B1(dry) | 2500 | 6.9 | 18.3 | 38.4 |
| C1(dry) | 500 | 8.6 | 21.1 | 42.9 |
| C3(dry) | 500 | 7.5 | 19.8 | 42.7 |

### Example 9

Activated alumina spheres were prepared from flash calcined gibbsite according to the following procedure: A gibbsite alumina powder (d50 of about 6 micrometers) was milled and flash activated. About 250 g of the powder was agglomerated into spheres using water as a binder over a time period of approximately 1 hour. The samples were aged for 3 hours at about 70° C. The resulting wet boehmitic spheres were heated to about 400° C. to obtain a surface area of about 325 m²/gram. The samples were subsequently split, with one portion having Na₂O removed according to the procedure of Example 1. This procedure results in a low sodium alumina adsorbent and/or catalyst support material that has an Na₂O content of about 500 ppm (C0).

X-Ray diffraction patterns were measured with a Rigaku Miniflex 600 which uses a 2.0 kW Cu X-Ray tube. Data was generated by scanning diffraction angles (Θ/2Θ) between 10 and 80 degrees, with a diffracted beam monochromator. The scanning rate was 2.0 degrees/minute with sampling width of 0.02 degrees.

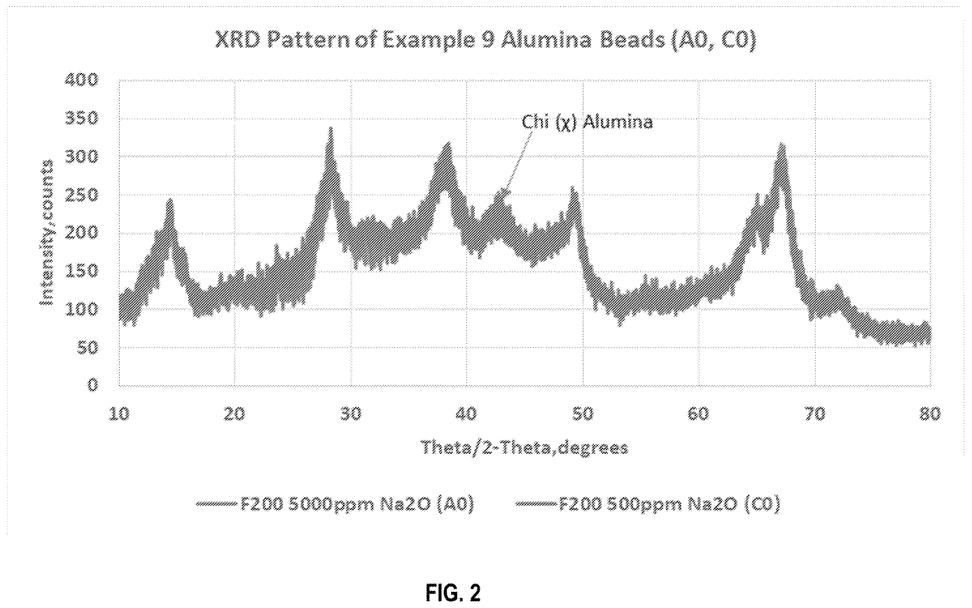

The resulting low-sodium alumina contains boehmite and gamma alumina, but also a significant amount of chi (χ) alumina. The XRD patterns are shown in FIG. 2, where the × phase is clearly visible. X-ray diffraction data is also shown in FIG. 2 for Samples A0 and C0, clearly indicating a presence of chi alumina at Θ/2Θ of about 42.5°.

### Example 10

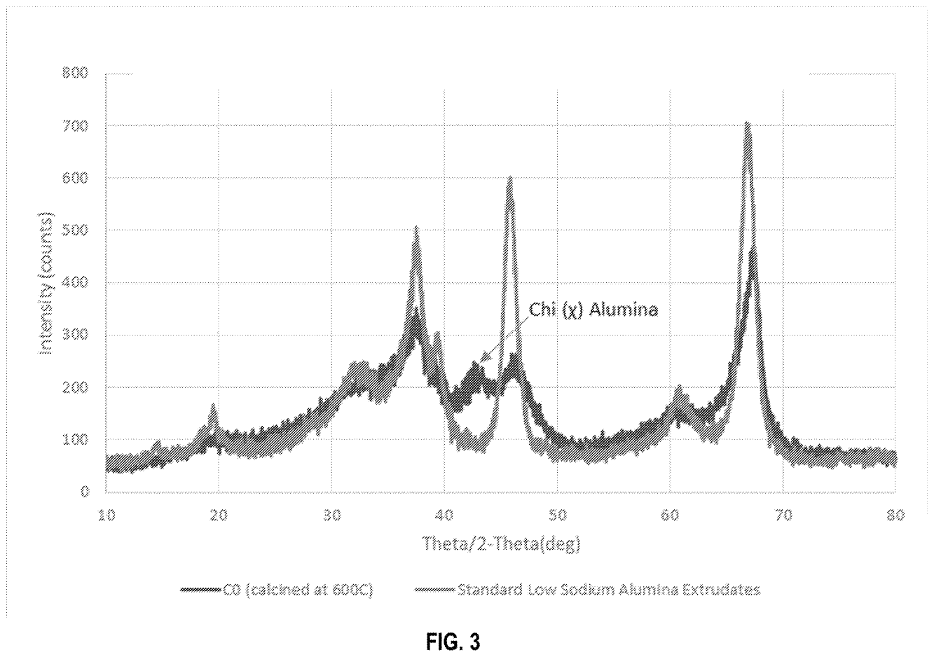

FIG. 3 demonstrates that the low sodium alumina prepared as described above (C0 with <500 ppm Na₂O) has a unique chi phase component, which is maintained even after calcination to remove the boehmite is performed. The X-ray diffraction analysis of the low sodium alumina is compared to standard formed alumina substrates. Other formed low sodium alumina materials (having Na₂O<500 ppm) were analyzed, with their spectra in FIG. 3 demonstrating the absence of chi alumina. Examples were obtained that were derived from both sulfate precipitated and alkoxide derived pseudoboehmite.

It is believed that the embodiments described herein represent the first example of a hydrothermally stable low sodium alumina adsorbent with a significant chi phase component. Surprisingly, low soda alumina with a chi phase exhibits high steam stability.

In the foregoing description, numerous specific details are set forth, such as specific materials, dimensions, processes parameters, etc., to provide a thorough understanding of the embodiments of the present disclosure. The particular features, structures, materials, or characteristics may be combined in any suitable manner in one or more embodiments. The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Reference throughout this specification to “an embodiment”, “certain embodiments”, or “one embodiment” means that a particular feature, structure, or characteristic described in connection with the embodiment is included in at least one embodiment. Thus, the appearances of the phrase “an embodiment”, “certain embodiments”, or “one embodiment” in various places throughout this specification are not necessarily all referring to the same embodiment, and such references mean “at least one”.

It is to be understood that the above description is intended to be illustrative, and not restrictive. Many other embodiments will be apparent to those of skill in the art upon reading and understanding the above description. The scope of the disclosure should, therefore, be determined with reference to the appended claims, along with the full scope of equivalents to which such claims are entitled.

1. An activated alumina having an Na₂O content of no more than about 4000 ppm, the activated alumina comprising a chi alumina phase.

2. The activated alumina of claim 1, wherein the activated alumina has an Na₂O content of no more than about 3500 ppm.

3. The activated alumina of claim 1, wherein the activated alumina is steamed at least once, and wherein a loss of surface area of the activated alumina after steaming is less than 20% compared to the activated alumina without steaming.

4. The activated alumina of claim 1, further comprising boehmite and gamma alumina phases.

5. The activated alumina of claim 1, wherein a BET surface area of the activated alumina adsorbent is less than about 400 m²/g.

6. The activated alumina of claim 1, wherein the activated alumina is formed from flash calcined gibbsite.

7. The activated alumina of claim 1, wherein, when measured by X-ray diffraction (XRD), the XRD spectrum of the activated alumina exhibits a peak at about 42.5° having a relative intensity of at least about 0.2 compared to a gamma alumina peak in the XRD spectrum.

8. A catalyst comprising the activated alumina of claim 1 as a support material.

9. An adsorbent comprising the activated alumina of claim 1.

10. An activated alumina having an Na₂O content of no more than about 4000 ppm, the activated alumina having been formed from flash calcined gibbsite.

11. A method of producing low-soda activated alumina having an Na₂O content of no more than about 4000 ppm, the method comprising:
acid washing activated alumina beads to leach Na₂O, wherein the activated alumina beads have an initial Na₂O content greater than 4000 ppm prior to the acid washing; and
subsequently drying the activated alumina beads.

12. The method of claim 11, wherein the acid washing comprises acid washing with hydrochloric acid at a temperature of greater than 90° C.

13. The method of claim 11, further comprising:
steaming the low-soda activated alumina in a sealed vessel, wherein a loss of surface area of the activated alumina after steaming is less than 20% compared to the activated alumina without steaming.

14. The method of claim 11, further comprising:
agglomerating milled gibbsite alumina powder to form gibbsite beads;
flash calcining the gibbsite beads to form the low-soda activated alumina.

15. The method of claim 11, wherein the activated alumina of claim 1, further comprising boehmite and gamma alumina phases.

16. The method of claim 11, wherein, when measured by X-ray diffraction (XRD), the XRD spectrum of the low-soda activated alumina exhibits an peak at about 42.5°.

17. The method of claim 11, further comprising incorporating the low-soda activated alumina into a catalyst composition as a support material.

18. The method of claim 11, further comprising incorporating the low-soda activated alumina into an adsorbent bed.
